(19) United States
(12) Patent Application Publication
(10) Pub. No.: US 2021/0233573 A1
(43) Pub. Date: Jul. 29, 2021

(54) ELECTRONIC DEVICE

(71) Applicant: CANON KABUSHIKI KAISHA, Tokyo (JP)

(72) Inventor: Takaya Yamazaki, Chiba (JP)

(21) Appl. No.: 17/148,317

(22) Filed: Jan. 13, 2021

(30) Foreign Application Priority Data
Jan. 23, 2020 (JP) 2020-009432

(51) Int. Cl. G11B 33/12; B41J 29/393

(52) U.S. Cl. CPC G11B 33/122; B41J 29/393

(57) ABSTRACT

An image forming apparatus includes a hard disk that includes a Staggered Spin-up (SSU) terminal that determines a spin-up start condition, a control unit that outputs a command to the hard disk, a Serial Advanced Technology Attachment (SATA) power supply cable that includes a hard disk drive (HDD) connector to be connected to a connector of the hard disk and a controller connector to be connected to a connector of the control unit, and a short circuit portion that connects a SSU terminal of the HDD connector to be connected to the SSU terminal and a terminal of the HDD connector to be connected to a ground potential.

### BACKGROUND OF THE INVENTION

### Field of the Invention

The present invention relates to an electronic device equipped with a hard disk having a Staggered Spin-up (SSU) function.

### Description of the Related Art

An electronic device such as an image forming apparatus is equipped with a storage such as a hard disk drive (HDD), which is a storage device for storing a large amount of data. The HDD has a Staggered Spin-up (SSU) function based on Serial Advanced Technology Attachment (SATA) standards and includes a SSU port to control the SSU function (Japanese Patent Application Laid-Open No. 2009-271637). The SSU function is a function of distributing a load put on a power supply by changing a spin-up timing of each HDD, and the function is expected to be used in a server that uses a plurality of HDDs. The SSU function is enabled or disabled by a HDD controller inside the HDD based on a logic (Low/High) of a signal input to the SSU port. In a case where the SSU port is at a Low level (the SSU function is disabled), the HDD controller starts spin-up as soon as the power supply is turned on. On the other hand, in a case where the SSU port is at a High level (the SSU function is enabled), the HDD controller starts the spin-up after receiving a SATA command Thus, if the power supply to the HDD is turned on, the HDD waits for the SATA command, and thus starting of the spin-up is delayed.

For example, in a device that includes a small number of HDDs, a load put on the power supply due to the spin-up of the HDD is not large. Thus, the SSU port is fixed to the Low level in some cases to accelerate the start of the spin-up. In order to fix the SSU port of the HDD to the Low level, a control unit that transmits a command to the HDD fixes the SSU port to the Low level via a wire.

However, in a conventional technique, a wire for connecting the SSU port of the HDD with the control unit is required to fix the SSU port to the Low level.

### SUMMARY OF THE INVENTION

The present invention is directed to provision of an electronic device that can fix a potential of a SSU port of a HDD at a predetermined level without using a wire.

According to an aspect of the present invention, an electronic device includes a hard disk including a control terminal configured to determine a spin-up start condition, a control unit configured to output a command to the hard disk, a cable including a first connector to be connected to a connector of the hard disk and a second connector to be connected to a connector of the control unit, and a connection portion configured to connect a first terminal of the first connector to be connected to the control terminal and a second terminal of the first connector to be connected to a ground potential.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image forming apparatus according to a first exemplary embodiment.

FIG. 2 is a block diagram illustrating a power supply unit of the image forming apparatus according to the first exemplary embodiment.

FIG. 3 illustrates details of a Serial Advanced Technology Attachment (SATA) power supply cable according to the first exemplary embodiment.

FIG. 4 illustrates details of a SATA power supply cable according to a second exemplary embodiment.

FIG. 5 illustrates details of a SATA power supply cable according to a third exemplary embodiment.

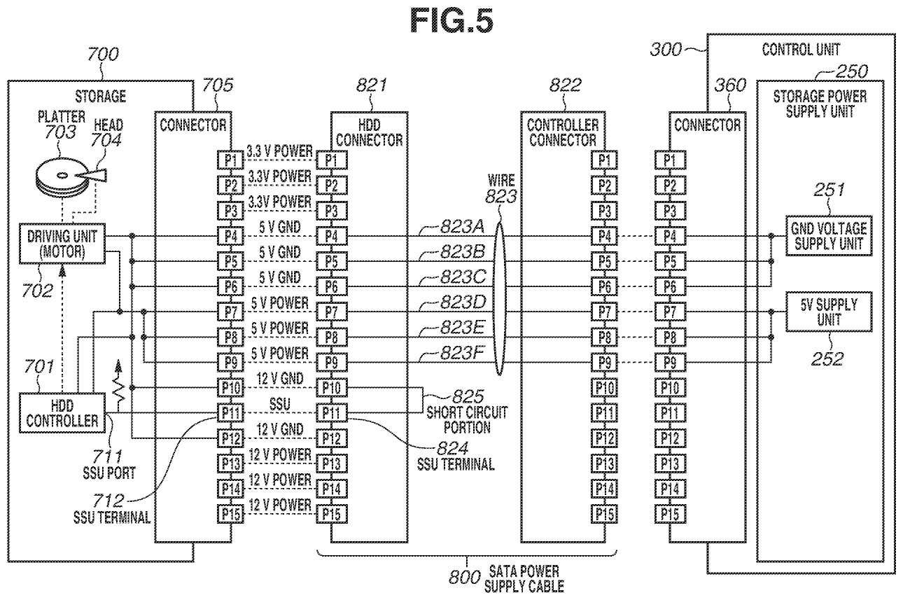

### DESCRIPTION OF THE EMBODIMENTS

Exemplary embodiments of the present invention will be described in detail below with reference to the attached drawings. An image forming apparatus having a printing function is described here as an example of an electronic device.

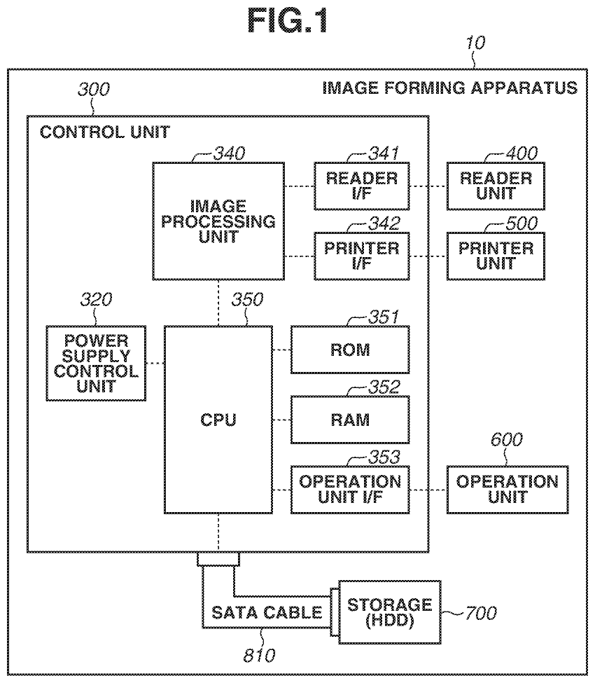

FIG. 1 is a block diagram illustrating a configuration of an image forming apparatus 10 according to a first exemplary embodiment. The image forming apparatus 10 includes a control unit 300, a reader unit 400, a printer unit 500, an operation unit 600, and a storage 700.

The reader unit 400 is a reading unit (corresponding to a reading unit according to claim 10) that reads a document and generates image data corresponding to the read document. The printer unit 500 is a printing unit (corresponding to a printing unit according to claim 9) that forms an image on a recording medium such as paper based on the image data. The operation unit 600 outputs an operation signal corresponding to an operation received from a user to the control unit 300 and includes, for example, a touch panel. The operation unit 600 further includes a display unit that displays information about the image forming apparatus 10. The touch panel is provided on a surface of the display unit.

The storage 700 is a large capacity storage for storing data and is a hard disk drive (HDD) according to the first exemplary embodiment. The storage 700 and the control unit 300 are connected with each other in a communicable manner via a Serial Advanced Technology Attachment (SATA) cable (corresponding to a cable according to claim 11) 810. The storage 700 is a nonvolatile storage medium and stores control data and user data used in the image forming apparatus 10.

The control unit 300 includes a power supply control unit 320, an image processing unit 340, and a central processing unit (CPU) 350. The control unit 300 further includes a read-only memory (ROM) 351, a random access memory (RAM) 352, and an operation unit interface (I/F) 353 that are connected to the CPU 350 in a communicable manner. The control unit 300 further includes a reader I/F 341 and a printer I/F 342 that are connected to the image processing unit 340 in a communicable manner.

The power supply control unit 320 supplies and stops power to be supplied to a load from a power supply unit 200 that is described below. The CPU 350 executes various types of calculation processing. The CPU (corresponding to a control unit according to claim 1) 350 outputs a command in conformity with SATA standards to the storage 700. The image processing unit 340 is a hard logic for executing image processing and executes, for example, correction, processing, color conversion, filtering processing, and resolution conversion on the image data. The ROM 351 is a nonvolatile storage medium and stores operation values (a constant, a variable, and the like) used in the calculation processing by the CPU 350 and a control program. The RAM 352 is a volatile storage medium and functions as a working memory in which a program in the ROM 351 is loaded and executed. The CPU 350 accesses the ROM 351, the RAM 352, and the storage 700 that are the storage media to execute a program and reading and writing of data.

The operation unit I/F 353 connects the CPU 350 and the operation unit 600. The CPU 350 executes processing based on an operation signal (for example, a copy instruction) from the operation unit 600 and controls each unit in the image forming apparatus 10 to implement an operation instructed by a user. The reader I/F 341 connects the image processing unit 340 and the reader unit 400. The printer I/F 342 connects the image processing unit 340 and the printer unit 500. The reader unit 400 and the printer unit 500 operate under control of the CPU 350 via the image processing unit 340.

For example, in copy processing, the reader unit 400 executes a reading operation on a document, generates image data, and supplies the image data to the image processing unit 340 based on the control of the CPU 350 via the image processing unit 340. The image processing unit 340 executes various types of image processing on the image data from the reader unit 400 and supplies the image data to the printer unit 500. The printer unit 500 prints the image data from the image processing unit 340 on a medium based on the control of the CPU 350 via the image processing unit 340.

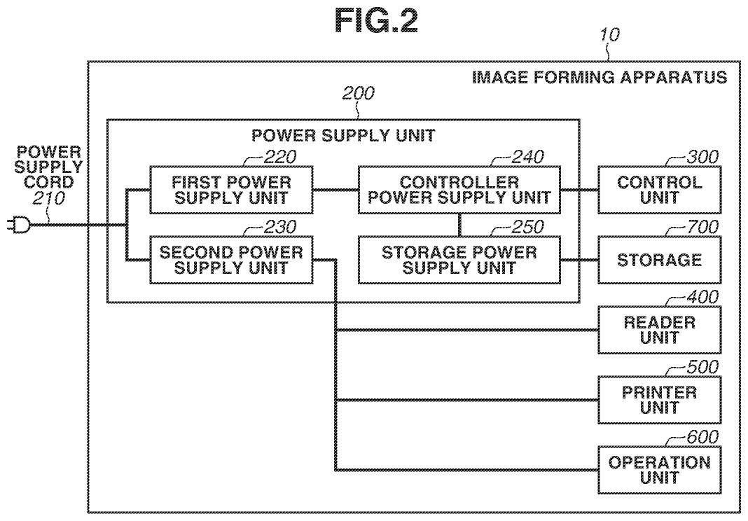

FIG. 2 is a block diagram illustrating the power supply unit 200 of the image forming apparatus 10. Thick solid lines in FIG. 2 indicate voltage supply lines.

The power supply unit 200 includes a first power supply unit 220 and a second power supply unit 230. Both the first power supply unit 220 and the second power supply unit 230 are alternating current (AC) to direct current (DC) converters and convert an AC voltage input via a power supply cord 210 into a DC voltage. A plug of the power supply cord 210 is connected to an external power supply of a commercial power supply or the like. The second power supply unit 230 outputs a voltage higher than a voltage of the first power supply unit 220. The power supply unit 200 further includes a controller power supply unit 240 and a storage power supply unit 250. Both the controller power supply unit 240 and the storage power supply unit 250 are DC-DC converters and step down or step up the DC voltage output from the first power supply unit 220. The controller power supply unit 240 supplies the voltage to each unit in the control unit 300. The voltage output from the controller power supply unit 240 is adjusted to an operation voltage of each unit in the control unit 300. The storage power supply unit 250 supplies the voltage to the storage 700. The voltage output from the storage power supply unit 250 is supplied to the storage 700 via the SATA cable 810.

The second power supply unit 230 supplies the voltage to the reader unit 400, the printer unit 500, and the operation unit 600. The voltage output from the second power supply unit 230 is adjusted to an operation voltage of each unit (the reader unit 400, the printer unit 500, and the operation unit 600). An output system such as the display unit of the operation unit 600 is supplied with the voltage output from the second power supply unit 230, and an input system such as the touch panel is supplied with the voltage output from the controller power supply unit 240. Accordingly, the input system such as the touch panel can detect a user operation in a sleep state in which the voltage is not supplied from the second power supply unit 230 and can recover from the sleep state. The power supply control unit 320 turns ON or OFF a switch (not illustrated) to supply the voltage to a load in the image forming apparatus 10 or to stop supply of the voltage thereto. In a case where a predetermined sleep shift condition is satisfied, the power supply control unit 320 stops the supply of the voltage to the reader unit 400, the printer unit 500, the display unit of the operation unit 600, the storage 700, and a part of the control unit 300. The part of the control unit 300 is, for example, the CPU 350, the image processing unit 340, the ROM 351, the reader I/F 341, and the printer I/F 342. The above-described sleep shift condition includes, for example, a lapse of a predetermined time without reception of a print job, and a lapse of a predetermined time without an operation on the touch panel of the operation unit 600.

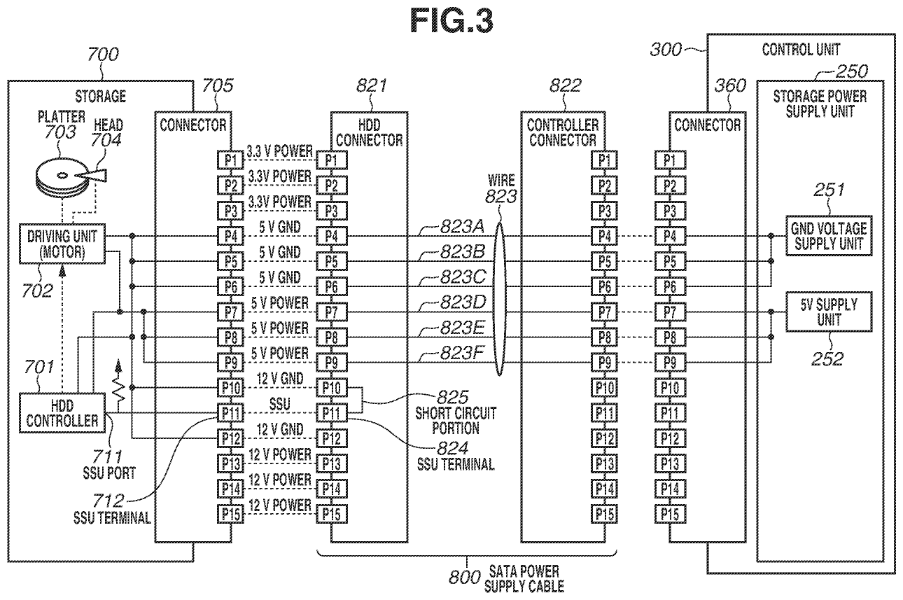

FIG. 3 illustrates details of a SATA power supply cable 800 according to the first exemplary embodiment. The SATA cable 810 includes a SATA signal cable (not illustrated) and the SATA power supply cable 800. The SATA signal cable includes seven wires. The seven wires includes three ground (GND) lines and two pairs of (four) data lines. The SATA power supply cable 800 is a cable defined by the SATA standards and includes seven wires. The SATA power supply cable 800 according to the first exemplary embodiment includes six wires.

The storage power supply unit 250 includes a GND voltage supply unit 251 and a 5-volt (V) supply unit 252. The GND voltage supply unit 251 supplies a reference voltage (GND voltage) to the storage 700. The reference voltage is approximately 0 V. The 5V supply unit 252 supplies an operation voltage of the storage 700. A voltage necessary to drive the storage 700 according to the first exemplary embodiment is 5 V. Thus, the storage power supply unit 250 supplies the voltage of 5 V to the storage 700.

The storage 700 according to the first exemplary embodiment is a HDD and includes a HDD controller 701, a driving unit 702 such as a motor, a platter 703, a head 704, a cache memory (not illustrated), and a connector 705. The HDD controller 701 performs driving of the driving unit 702, input and output of data to and from the control unit 300, and input and output of data to and from the cache memory. The HDD controller 701 further includes a Staggered Spin-up (SSU) port 711. The SSU port 711 is connected with a SSU terminal (corresponding to a control terminal according to claim 1) 712 for determining a spin-up start condition of the HDD. The SSU port 711 and the SSU terminal 712 are connected to a pull-up resistor. The SSU port 711 of the HDD controller 701 is at a High level by a voltage applied to the pull-up resistor unless the SSU terminal 712 becomes a Low level. At this time, the HDD controller 701 determines that the SSU function is ON and starts the spin-up based on a predetermined SATA command transmitted from the control unit 300. If the SSU terminal 712 becomes the Low level, the SSU port 711 of the HDD controller 701 becomes the Low level. At this time, the HDD controller 701 determines that the SSU function is OFF. If the SSU function is OFF, the HDD controller 701 starts the spin-up with the supply of voltage.

The SATA power supply cable 800 (corresponding to a cable according to claim 1) is a cable for supplying the voltage to a device (HDD) in conformity with the SATA standards from the storage power supply unit 250. The SATA power supply cable 800 includes an HDD connector 821 (corresponding to a first connector according to claim 1), a controller connector 822 (corresponding to a second connector according to claim 1), and a wire 823. The HDD connector 821 is connected with the connector 705 of the storage 700. The HDD connector 821 is in conformity with the SATA standards and includes 15 terminals (P1 to P15). The terminals P1 to P3 supply a voltage of 3.3 V. The terminals P4 to P6 supply the GND voltage. The terminals P7 to P9 supply a voltage of 5 V. The terminal P10 (corresponding to a second terminal according to claim 1) is connected to a ground potential (reference potential) of the storage 700 (HDD). The terminal P11 is a SSU terminal (corresponding to a first terminal according to claim 1) 824 connected to the SSU terminal 712. The terminal P12 is connected to the ground potential. The terminals P13 to P15 supply a voltage of 12 V. The terminals P10 and P12 are connected to the reference potential (ground potential) supplied by wires 823A to 823C in the storage 700.

The controller connector 822 is connected to a connector 360 of the control unit 300. The controller connector 822 is also in conformity with the SATA standards and includes 15 terminals (P1 to P15) as with the above-described HDD connector 821. The terminals P1 to P3 supply a voltage of 3.3 V. The terminals P4 to P6 supply the GND voltage. The terminals P7 to P9 supply a voltage of 5 V. The terminal P10 supplies the GND voltage. The terminal P11 is a SSU terminal. The terminal P12 supplies the GND voltage. The terminals P13 to P15 supply a voltage of 12 V.

The wire 823 according to the first exemplary embodiment includes six wires. The wire 823 is formed by coating a conductive member such as tin-plated copper with an insulator such as polyvinyl chloride. The wire 823 includes wires 823A to 823F. The wire 823A connects the terminal P4 of the HDD connector 821 with the terminal P4 of the controller connector 822. The wire 823B connects the terminal P5 of the HDD connector 821 with the terminal P5 of the controller connector 822. The wire 823C connects the terminal P6 of the HDD connector 821 with the terminal P6 of the controller connector 822. The wire 823D connects the terminal P7 of the HDD connector 821 with the terminal P7 of the controller connector 822. The wire 823E connects the terminal P8 of the HDD connector 821 with the terminal P8 of the controller connector 822. The wire 823F connects the terminal P9 of the HDD connector 821 with the terminal P9 of the controller connector 822. In the first exemplary embodiment, there is no wire connecting the terminal P11 of the HDD connector 821 with the terminal P11 of the controller connector 822.

In the first exemplary embodiment, a short circuit portion (corresponding to a connection portion according to claim 1) 825 is provided. The short circuit portion 825 electrically connects the terminal P11 (corresponding to the first terminal according to claim 1) of the HDD connector 821 with the terminal P10 (corresponding to the second terminal according to claim 1) adjacent to the terminal P11. The short circuit portion 825 connects the terminal P11 with the terminal P10, which is a ground terminal disposed between the terminal P11 and the terminal P9 to which the wire 823F for supplying the operation voltage is connected. The short circuit portion 825 is provided on an inside of the HDD connector 821. The terminal P10 is connected to the GND potential of the storage 700 or the GND potential of the control unit 300, so that the terminal P11 of the HDD connector 821 becomes the GND potential. Thus, the SSU terminal 712 of the storage 700 connected to the terminal P11 becomes the Low level (GND potential), and the SSU port 711 of the HDD controller 701 becomes the Low level (the GND potential). Accordingly, the HDD controller 701 determines that the SSU function is OFF and starts the spin-up with the supply of the voltage.

In the first exemplary embodiment, the voltage supplied to the SSU port 711 of the HDD controller 701 becomes the GND potential via the short circuit portion 825, so that the SSU function can be turned OFF. Further, in the first exemplary embodiment, the terminal P11 of the HDD connector 821 can be set to the GND potential without using a wire, and thus a cost can be reduced by an amount of a wire connecting the terminal P11 of the HDD connector 821 with the terminal P11 of the controller connector 822.

Further, in the first exemplary embodiment, the terminal P11 can be set to the GND potential using a simple method of connecting the terminal P11 of the HDD connector 821 to the adjacent terminal P10. Alternatively, the terminal P11 of the HDD connector 821 may be connected to the adjacent terminal P12. Yet alternatively, the terminal P11 of the HDD connector 821 may be connected to any of the terminals P4, P5, and P6 of the HDD connector 821.

In the first exemplary embodiment, the example is described in which the short circuit portion 825 is provided on the inside of the HDD connector 821. In the first exemplary embodiment, the SSU function is always turned OFF due to provision of the short circuit portion 825. However, the SSU function may be used in some cases depending on a user. Thus, in a second exemplary embodiment, a configuration is described in which OFF and ON of the SSU function can be switched.

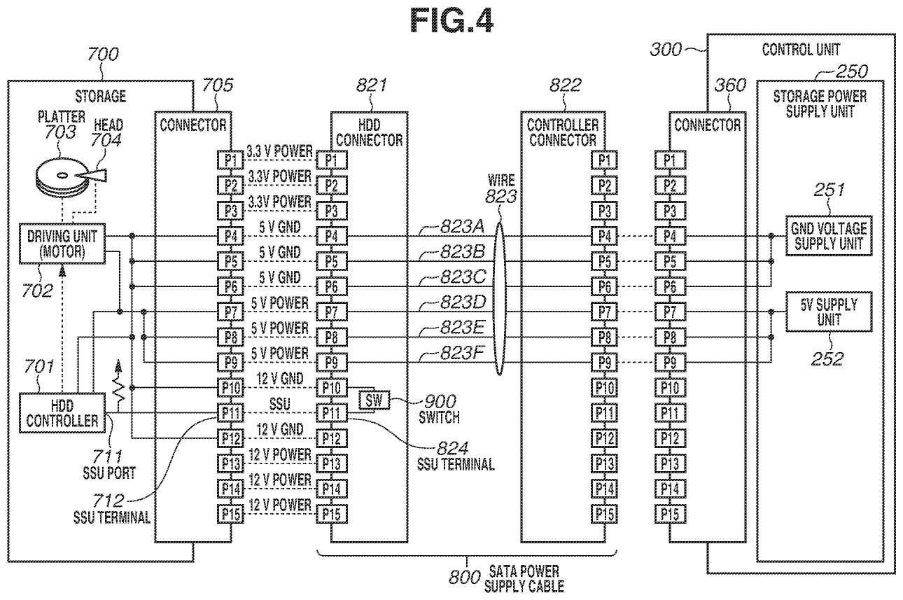

FIG. 4 illustrates details of a SATA power supply cable 800 according to the second exemplary embodiment. In the second exemplary embodiment, a switch 900 is provided between the terminal P10 (ground terminal) and the terminal P11 (SSU terminal 824) of the HDD connector 821. The other reference numerals are the same as the reference numerals in FIG. 3. The switch 900 is an element that can switch between conduction and non-conduction (short circuit and opening) between the terminal P10 and the terminal P11.

In a case where the switch 900 is ON, the terminal P10 and the terminal P11 (SSU terminal 824) are short-circuited. If the storage 700 and the storage power supply unit 250 are connected by the SATA power supply cable 800, the terminal P11 (SSU terminal 824) becomes the GND potential. At this time, the HDD controller 701 determines that the SSU function is OFF. On the other hand, in a case where the switch 900 is OFF, the SSU port 711 of the HDD controller 701 becomes the High level by the voltage applied to the pull-up resistor in the storage 700. At this time, the HDD controller 701 determines that the SSU function is ON.

In the second exemplary embodiment, the switch 900 is provided between the terminal P10 and the terminal P11, and thus the SSU function can be turned ON or OFF. In the second exemplary embodiment, as with the first exemplary embodiment, the terminal P11 of the HDD connector 821 can be set to the GND potential without using a wire, and thus the cost can be reduced by the amount of the wire connecting the terminal P11 of the HDD connector 821 with the terminal P11 of the controller connector 822.

In the first exemplary embodiment, the example is described in which the short circuit portion 825 is provided on the inside of the HDD connector 821. In a third exemplary embodiment, the short circuit portion 825 is disposed so that a part of the short circuit portion 825 is exposed to an outside of the HDD connector 821. Compared with the first exemplary embodiment in which the short circuit portion 825 is provided on the inside of the HDD connector 821, in the third exemplary embodiment, the part of the short circuit portion 825 is disposed on the outside of the HDD connector 821, and thus, it is easy to recognize that the terminal P10 and the terminal P11 of the HDD connector 821 are short-circuited.

### [Modification]

In the above-described exemplary embodiments, the examples are described in which the HDD connector 821 in which the terminal P11 as the SSU terminal and the terminal P10 adjacent to the terminal P11 are short-circuited is connected to the image forming apparatus 10. However, the HDD connector 821 may be applied to an electronic device such as a personal computer or a server.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-009432, filed Jan. 23, 2020, which is hereby incorporated by reference herein in its entirety.

What is claimed is:

1. An electronic device comprising:
a hard disk including a control terminal configured to determine a spin-up start condition;
a control unit configured to output a command to the hard disk;
a cable including a first connector to be connected to a connector of the hard disk and a second connector to be connected to a connector of the control unit; and
a connection portion configured to connect a first terminal of the first connector to be connected to the control terminal and a second terminal of the first connector to be connected to a ground potential.

2. The electronic device according to claim 1, wherein the connection portion connects the first terminal and the second terminal adjacent to the first terminal.

3. The electronic device according to claim 1,
wherein the cable includes a wire that supplies an operation voltage to the hard disk, and
wherein the connection portion connects the first terminal and the second terminal disposed between the first terminal and a terminal to which the wire is connected.

4. The electronic device according to claim 1, wherein the connection portion is provided on an inside of the first connector.

5. The electronic device according to claim 1, wherein a part of the connection portion is exposed to an outside of the first connector.

6. The electronic device according to claim 1, wherein the second terminal is connected to a reference potential of the hard disk.

7. The electronic device according to claim 1,
wherein the cable includes a wire that supplies a reference potential to the hard disk, and
wherein the second terminal is connected to the reference potential supplied via the wire to the hard disk.

8. The electronic device according to claim 1, further comprising a switch configured to switch between conduction and non-conduction between the first terminal and the second terminal.

9. The electronic device according to claim 1, further comprising a printing unit configured to print an image on a recording medium.

10. The electronic device according to claim 1, further comprising a reading unit configured to read an image of a document.

11. A cable to be connected to a connector including a control terminal configured to determine a spin-up start condition of a hard disk, the cable comprising:
a first connector configured to be connected to the connector of the hard disk;
a second connector configured to be connected to a connector of a control unit that outputs a command to the hard disk; and
a connection portion configured to connect a first terminal of the first connector to be connected to the control terminal and a second terminal of the first connector to be connected to a ground potential.

12. The cable according to claim 11, wherein the connection portion connects the first terminal and the second terminal adjacent to the first terminal.

13. The cable according to claim 11, further comprising a wire that supplies an operation voltage to the hard disk,
wherein the connection portion connects the first terminal and the second terminal disposed between the first terminal and a terminal to which the wire is connected.

14. The cable according to claim 11, wherein the connection portion is provided on an inside of the first connector.

15. The cable according to claim 11, wherein a part of the connection portion is exposed to an outside of the first connector.

16. The cable according to claim 11, wherein the second terminal is connected to a reference potential of the hard disk.

17. The cable according to claim 11, further comprising a wire that supplies a reference potential to the hard disk,
wherein the second terminal is connected to the reference potential supplied via the wire to the hard disk.

18. The cable according to claim 11, further comprising a switch configured to switch between conduction and non-conduction between the first terminal and the second terminal.
